(19) United States
(12) Patent Application Publication
(10) Pub. No.: US 2002/0074798 A1
(43) Pub. Date: Jun. 20, 2002

(54) Sanitary seal

(76) Inventors: Timothy C. Duzick, Hockessin, DE (US); Thomas C. Lucier, Mebane, NE (US)

Correspondence Address: DUPONT DOW ELASTOMERS, LLC, LEGAL DEPARTMENT -- PATENTS, 1007 MARKET STREET, WILMINGTON, DE, 19898, US

(21) Appl. No.: 09/736,713

(22) Filed: Dec. 14, 2000

Related U.S. Application Data
(60) Provisional application No. 60/173,397, filed on Dec. 28, 1999.

(51) Int. Cl. F16L 17/00

(52) U.S. Cl. 285/379

(57) ABSTRACT

The present invention is directed to a seal assembly for use in sealing a joint between grooved pipe joint ferrules and in particular to a sanitary seal assembly. The seal assembly has an annular retaining part that has a seal cavity and an elastomeric seal shaped to fit within the cavity and is positioned by the cavity.

The elastomeric seal and the pipe joint made with the seal assembly are also considered part of this invention.

### CROSS-REFERENCE TO RELATED APPLICATION

This application claims the benefit of U.S. Provisional Application 60/173,397 filed Dec. 28, 1999.

### FIELD OF THE INVENTION

The present invention relates to a seal for pipe joints and in particular to a sanitary (also referred to as hygienic or aseptic) seal for pipe joints used in pharmaceutical, food processing, select semiconductor, and other related applications.

### BACKGROUND OF THE INVENTION

Manufacture of pharmaceuticals and foods requires sanitary equipment in order to prevent contamination of the product. One potential source of contamination is from pipe joints in product transfer lines. Bacteria and other contaminants may be introduced through the joints from the external environment outside the pipe joint. Another source of contamination is internal wherein small amounts of products that had been previously manufactured may be deposited at pipe joints and then are incorporated into subsequent products as they pass through the transfer line. Also, products deposited at the pipe joints may act as a breeding ground for bacteria which may contaminate subsequent products.

Various designs of metal seals, elastomer seals, and metal/elastomer combination seals have been used in the prior art as sanitary seals at pipe joints. These seals have suffered from problems such as poor sealing; creation of dead spaces at joints into which products may deposit as they pass through the pipe; intrusion of the elastomer seal into the area in which the product flows; splitting of the elastomer seal due to either thermal expansion or to the compressive force applied to the elastomer at the joint, and extraction of contaminants from the elastomer seal by contact of the seal with product that is flowing by.

### SUMMARY OF THE INVENTION

The present invention is directed to a seal assembly for use in sealing a joint between grooved pipe joint ferrules and in particular to a sanitary seal assembly. The seal assembly has an annular retaining part that has a seal cavity and an elastomeric seal shaped to fit within the cavity and is positioned by the cavity. The annular retaining part has an interior bowl shaped portion where the bowl has an opening and an annular interior cavity and the opening has a diameter less than the maximum diameter of the annular cavity within the bowl shaped portion and has an interior surface adjacent to the bowl opening that has a seal retaining region extending around the periphery of the bowl opening. Preferably, the surface of this seal retaining region is a flat section that is substantially perpendicular to the longitudinal axis of the annular retaining part. The elastomeric seal of the assembly when viewed in cross section has an annular forward seal portion that is larger in diameter than the diameter of the bowl opening into the bowl cavity and has an arcual forward surface which in cross section has first and second convex arcual portions separated by a trough like portion and a base surface that fits with the seal retaining region of the bowl shaped portion of the retaining ring and has a stem portion having a substantially rectangular shape and concave rear surface in the uncompressed state. When the stem is compressed by the ferrules of the two adjoining pipes the stem is forced into sealing engagement with the pipe ferrules and the concave rear surface of the stem is deformed into a nearly flat surface thereby providing a smooth flat surface between the two pipes.

The elastomeric seal and the pipe joint made with the seal assembly are also considered part of this invention.

### BRIEF DESCRIPTIONS OF THE DRAWINGS

FIG. 1 is a top view of the seal assembly of this invention.

FIG. 2 is a cross-section view of the seal assembly of this invention taken along lines ‘2’-‘2’ of FIG. 1.

FIG. 3 is a fragmentary view in cross-section of the seal assembly of this invention seated in a pipe joint wherein the joint is not tightened and the seal not compressed.

FIG. 4 is an enlarged fragmentary cross-section view of a pipe joint wherein the joint is tightened and the seal assembly and the seal are compressed.

### DETAILED DESCRIPTION OF THE INVENTION

Besides the preferred embodiment of the invention illustrated in the drawings and described in detail below, the skilled artisan will readily understand that the invention is capable of alternative embodiments. Accordingly the invention should not be strictly limited in scope to the preferred embodiment.

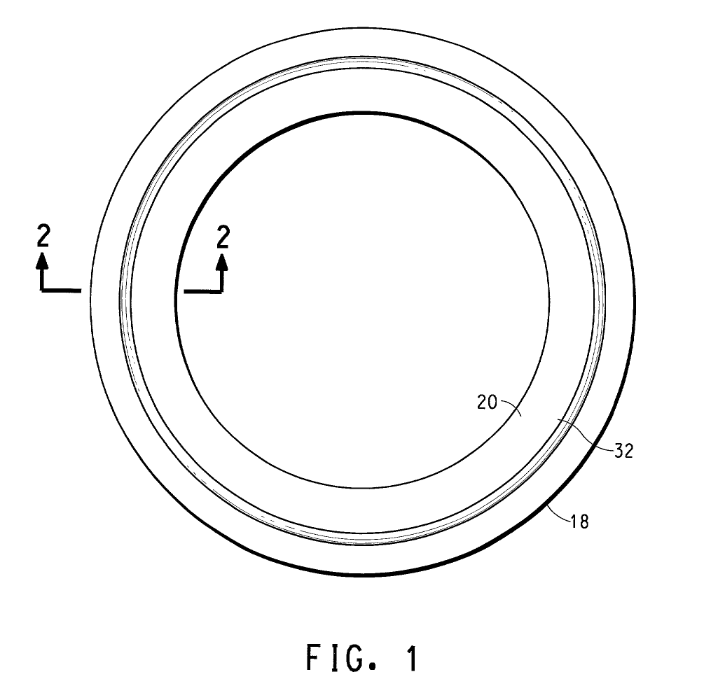

FIG. 1 shows a top view of the seal assembly of this invention wherein an inner elastomeric seal ring 20 is held in place by portion 32 of an annular retaining part or ring 18.

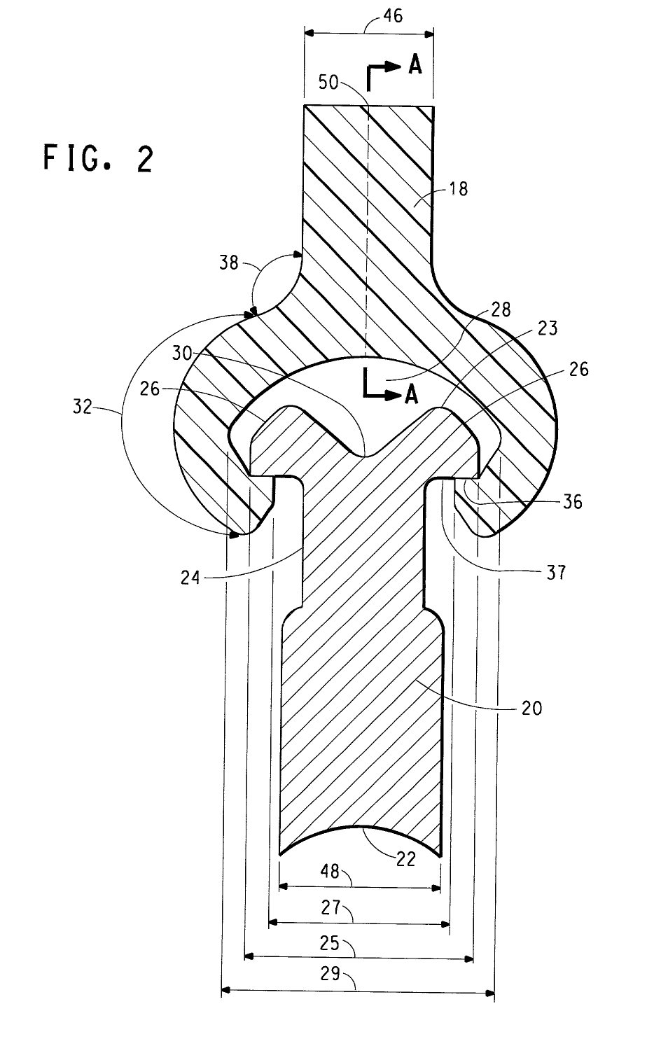

FIG. 2 shows in cross-section, annular retaining part or ring 18 holding elastomeric seal ring 20 in place via portion 32 of the retaining ring.

Referring to FIG. 2, the retaining ring 18 defines a bowl shaped portion 28. The bowl shaped portion 28 has an opening 27 and an annular interior cavity and the maximum diameter 29 of this cavity is larger than the maximum diameter of the opening 27. The interior surface 36 or seal retaining region of the cavity adjacent to the opening 27 preferably has a substantially flat region extending inward from the edge of the opening 27 and this surface preferably is substantially perpendicular to the longitudinal axis of the retaining ring 18 and prevents the seal ring 20 from slipping out of the interior cavity. A surface other than a flat surface can be used such as a curved surface, roughened surface, a surface with tooth like projections, or a Velcro® fastener surface. Also, instead of being perpendicular to the longitudinal axis of the retaining ring 18, the surface may slope down, for example, at a 10-20 degree angle toward the exterior of the retaining ring Also, the surface may be hook like in shape to hold the seal ring 20. Any design that will prevent the seal ring 20 from slipping out of the interior cavity of the retaining ring can be used.

In another alternate embodiment, the annular retaining part or ring 18 can be split at its radial center point 50 along line ‘A’-‘A’ in the form of two pieces, which would further facilitate installation of seal ring 20 into the bowl shaped portion 28 formed by the two pieces of retaining ring 18.

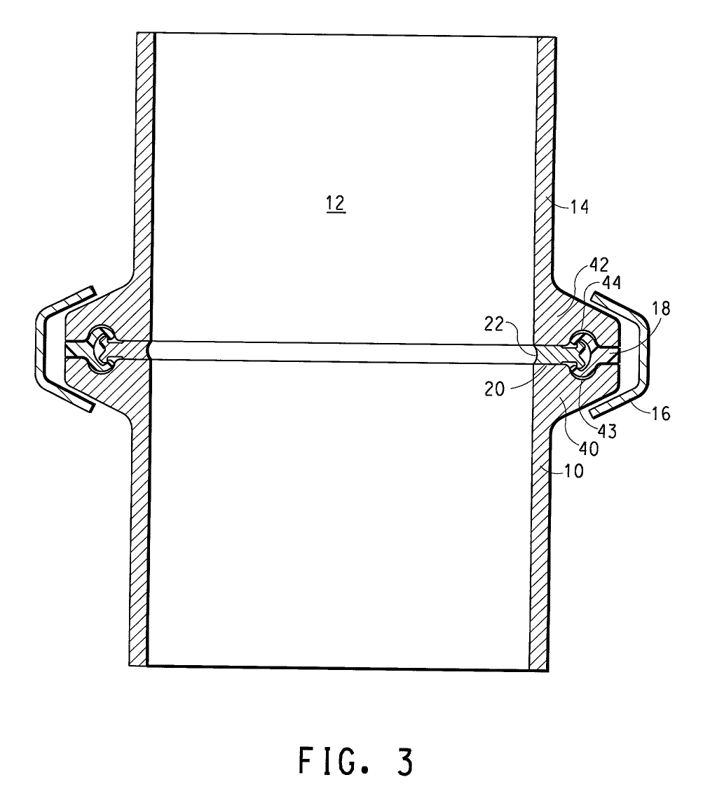

Continuing to refer to FIG. 2, the elastomeric seal ring 20 has an annular forward seal portion 23 that is larger in diameter 25 than the opening 27 of the bowl shaped portion 28. This keeps the forward seal portion 23 of the seal ring 20 in the bowl shaped portion 28 of the retaining ring 18. The seal ring 20 has an arcual forward surface which viewed in cross-section has first and second convex portions 26 and a trough like portion 30 between the convex portions. The trough like portion separates the convex portion (in cross-section). The trough like portion 30 is preferably, in cross section, concave in shape, but the trough portion can be varied in shape provided it is symmetrical, functions to separate the convex portions, allows for thermal expansion of the seal ring 20, and facilitates insertion and removal of the forward seal portion 23 of seal ring 20 into bowl shaped portion 28. This trough like portion 30 of the forward surface of the seal also facilitates installation and removal of the seal ring 20 from the bowl shaped portion 28 of the retaining ring 18. A skilled artisan will recognize that the base 37 of forward seal portion 23 should be shaped for mechanically mating with seal retaining region 36 in order to hold forward seal portion 23 within bowl 28. The base 37 of forward seal portion 23 is preferably substantially flat for positioning against the interior surface 36 of the bowl cavity. The seal ring 20 has a stem portion that is substantially rectangularly shaped directly connected to the forward portion 23 and has a rear surface 22 which is concave and deforms under compression from ferrules 40 and 42 to a nearly flat surface aligned with the surface of the two pipes being joined thereby eliminating a recess in which contaminants can accumulate (see FIG. 3). Optionally, region 24 of seal ring 20 may be sized thinner than the thickness 48 of the rear surface 22 of seal ring 20 in order to provide a geometric deformable region that allows easy installation of the seal ring 20 in retaining ring 18.

FIG. 3 shows a cross-section of the seal assembly as shown in FIG. 2 seated in a pipe joint where the joint has not been tightened and the elastomeric seal ring has not been compressed. FIG. 3 shows fragmentary pipe segments 10 and 14, which in an aligned, connected relation defines a through bore 12 for the transport of a gas or a liquid under pressure or vacuum. The pipe segments 10 and 14 have respective ferrules 40 and 42, having grooves 43 and 44, respectively, adapted to achieve a mating and aligned relationship with one another. The design of the ferrules and piping have been extensively documented in the American Society of Mechanical Engineers, Bioprocessing Equipment Standard dated 1997 (ASME BPE-1997). Two sections of pipe with ferrules 40 and 42 are jointed together by a clamping means 16. Clamping means 16 may be any of a variety of devices such as, but not limited to, toggle action clamps, wing nut clamps, or dual bolt clamps. Clamps can have two or more hinges to provide more consistent compression on the surface of ring 20. The two pipes are further aligned and joined and sealed by means of a seal ring 20. The retaining ring 18 positioned in grooves 43 and 44 also provides centric alignment of seal ring 20 with the inner diameter of pipe segments 10 and 14. Since the seal ring 20 is not under compression the rear surface 22 of the seal ring 20 is shown as being concave in shape.

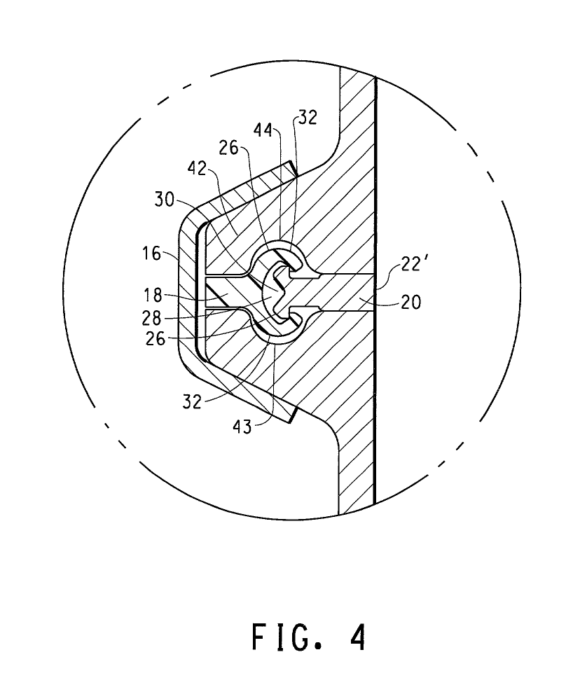

FIG. 4 shows a cross-section view of the pipe joint wherein the joint is tightened by the clamping means 16 and the seal assembly and the elastomeric seal ring 20 are under compression. The retaining ring 18 is positioned in grooves 43 and 44. Upon compression of the elastomeric seal ring 20, the concave rear surface of the seal is deformed to a nearly or substantially flat surface 22′, that is aligned with the interior of the two pipes. Compression of the seal ring also forces the forward portion of the seal ring into the cavity formed by the bowl shaped portion 28 of the retaining ring 18. There is sufficient space left between the wall of the bowl shaped portion 28 of the retaining ring and the convex arcual surfaces 26 of the forward portion of the seal to allow for thermal expansion of the seal ring 20. The trough like portion 30 of ring seal 20 allows space for expansion during compression of the seal and for thermal expansion which occurs under elevated temperature operating conditions.

Retaining ring 18 of the seal assembly controls the amount of compression applied by clamping means 16 to seal ring 20. Compression is controlled by the thickness 46 of the retaining ring 18 relative to the thickness 48 of seal ring 20 (see FIG. 2). Compression must be controlled in order to ensure that concave region 22 of seal ring 20 is pushed out so as to be flush 22′ with the interior of pipe segments 10 and 14 upon full compression (see FIG. 4). Too little compression will yield insufficient sealing properties. In a situation where there is insufficient sealing, a leak path will likely develop or dead space will be created at or near the interface of the inner surface of the seal ring and the inner diameter of the pipe segments 10 and 14 and there bacteria or other foreign contamination may accumulate. Too much compression can cause intrusion of seal ring 20 into the through bore 12 and contribute to premature seal ring failure by over straining the seal ring.

The convex regions 32 and concave regions 38 of the retaining ring 18 are designed and sized to fit complementarily into groove 43 and 44 of ferrules 40 and 42 (see FIGS. 2 & 4).

Retaining ring 18 can be fabricated using metals such as stainless steel, aluminum, or other non-deformable metal. Retaining ring 18 can also be made of polymers having either a modulus or a hardness much greater than that of the material used as the seal ring 20. Polymers, useful for preparation of retaining rings, include, but are not limited to, nylon, polyether ether ketone (PEEK), polyether sulfone (PES), polytetrafluoroethylene (PTFE), polyimide, or an organic or inorganic composite. In some end use applications, retaining ring 18 may be fabricated from a very high modulus (i.e. greater than 2500 psi (17.2 MPa) @ 100% strain) or high hardness elastomers (i.e. greater than 85 Shore A hardness).

Elastomeric seal ring 20 may be fashioned out of an elastomer or other deformable material such as a thermoplastic resin, for example, polytetrafluoroethylene, or polyethylene that is inert to the food, pharmaceutical, or other fluids which will pass through the pipe. The seal ring should preferably also be able to withstand sterilization processes and cleaning solvents or solutions such as ethylene oxide, vaporized hydrogen peroxide, chlorine-based cleaners, ultraviolet-based sterilizers, peracetic acid and other acids, caustics, and other chemical based sterilizing agents. The sealing ring should preferably also be able to withstand saturated steam at 130° C. or greater for a duration of 100 hours. Additional requirements for the seal ring material depend upon the nature of the pharmaceutical, food or other fluid that will flow through the pipe and might include, for instance, low levels of organic and inorganic extractables and minimal absorption characteristics (i.e. low volume swell in a broad range of chemicals). Suitable elastomers include ethylene-propylene-diene elastomers (EPDM), silicone rubbers, fluoroelastomers, and perfluoroelastomers. For applications requiring seals that may be exposed to high temperatures, harsh chemicals or require very low extractables, a perfluoroelastomer is the preferred elastomer. By “perfluoroelastomer” is meant copolymers comprising copolymerized units of tetrafluoroethylene and copolymerized units of a perfluoro(alkyl vinyl ether) or a perfluoro(alkoxy vinyl ether). Such copolymers may also contain a minor amount (preferably less than 7 mole percent, based on the total number of moles of comonomers) of a cure site such as Br, I, CN, or H. Perfluoroelastomers have been extensively described in the prior art. See, for example, U.S. Pat. Nos. 4,035,565; 4,281,092; 4,529,784; U.S. Pat. No. 4,487,903; U.S. Pat. No. 5,789,489; U.S. Pat. No. 5,936,060; and European Patent No. 872495.

Typically useful perfluoroelastomers for forming seal ring 20, are polymeric compositions having copolymerized units of at least two principal perfluorinated monomers. Generally, one of the principal comonomers is a perfluoroolefin while the other is a perfluorovinyl ether. Representative perfluorinated olefins include tetrafluoroethylene and hexafluoropropylene. Suitable perfluorinated vinyl ethers are those of the formula

CF₂=CFO (R_{f}′O)ₙ(R_{f}′′O)ₘR_{f} (I)

where R_{f}′ and R_{f}′ are different linear or branched perfluoroalkylene groups of 2-6 carbon atoms, m and n are independently 0-10, and Rf is a perfluoroalkyl group of 1-6 carbon atoms.

A preferred class of perfluoro(alkyl vinyl) ethers includes compositions of the formula

CF₂=CFO (CF₂CFXO)ₙR_{f} (II)

where X is F or CF₃, n is 0-5, and R_{f} is a perfluoroalkyl group of 1-6 carbon atoms.

Most preferred perfluoro(alkyl vinyl) ethers are those wherein n is 0 or 1 and R_{f} contains 1-3 carbon atoms. Examples of such perfluorinated ethers include perfluoro(methyl vinyl) ether and perfluoro(propyl vinyl) ether. Other useful monomers include compounds of the formula

CF₂=CFO [(CF₂)ₘCF₂CFZO]ₙR_{f} (III)

where R_{f} is a perfluoroalkyl group having 1-6 carbon atoms

m=0 or 1, n=0-5, and Z=F or CF₃

Preferred members of this class are those in which R_{f} is C₃F₇, m=0, and n=1. Additional perfluoro(alkyl vinyl) ether monomers include compounds of the formula

CF₂=CFO [(CF₂CFCF₃O)ₙ(CF₂ CF₂ CF₂O)ₘ(CF₂)ₚ]CₓF₂ₓ₊₁ (IV)

where m and n=1-10, p=0-3, and x=1-5.

Preferred members of this class include compounds where n=0-1, m=0-1, and x=1

Examples of useful perfluoro(alkoxy vinyl) ethers include

CF₂=CFOCF₂CF (CF₃)O(CF₂O)ₘCₙF₂ₙ₊₁ (V)

where n=1-5, m=1-3, and where, preferably, n=1.

Mixtures of perfluoro(alkyl vinyl) ethers and perfluoro(alkoxy vinyl) ethers may also be used.

Preferred copolymers are composed of tetrafluoroethylene and at least one perfluoro(alkyl vinyl) ether as principal monomer units. In such copolymers, the copolymerized perfluorinated ether units constitute from about 15-50 mole percent of total monomer units in the polymer.

Typically, the perfluoropolymer further contains copolymerized units of at least one cure site monomer, generally in amount of from 0.1-5 mole percent. The range is preferably between 0.3-1.5 mole percent. Although more than one type of cure site monomer may be present, most commonly one cure site monomer is used and it contains at least one nitrile substituent group. Suitable cure site monomers include nitrile-containing fluorinated olefins and nitrile-containing fluorinated vinyl ethers. Useful cyano-substituted cure site monomers include those of the formulas shown below.

CF₂=CF—O (CF₂)ₙ—CN (VI)

where n=2-12, preferably 2-6.

CF₂=CF—O[CF₂—CFCF₃—O—]ₙCF₂—CFCF₃—CN (VII)

where n=0-4, preferably 0-2; and

CF₂=CF—[OCF₂CFCF₃]ₓ—O—(CF₂)ₙ—CN (VIII)

where x=1-2, and n=1-4;

CF₂=CF—O—(CF₂)ₙ—O—CF(CF₃)CN (IX)

where n=2-5, and

CF₂=CF[OCF₂CF(CF₃)]ₙCN (X)

where n−1-5.

Those of formula (VIII) are preferred. Especially preferred cure site monomers are perfluorinated polyethers having a nitrile group and a trifluorovinyl ether group. A most preferred cure site monomer is

CF₂=CFOCF₂CF (CF₃) OCF₂CF₂CN (XI)

i.e. perfluoro(8-cyano-5-methyl-3,6-dioxa-1-octene) or 8-CNVE.

Other cure site monomers include olefins represented by the formula R₁CH=CR₂R₃, wherein R₁ and R₂ are independently selected from hydrogen and fluorine and R₃ is independently selected from hydrogen, fluorine, alkyl, and perfluoroalkyl. The perfluoroalkyl group may contain up to about 12 carbon atoms. However, perfluoroalkyl groups of up to 4 carbon atoms are preferred. In addition, the cure site monomer preferably has no more than three hydrogen atoms. Examples of such olefins include ethylene, vinylidene fluoride, vinyl fluoride, trifluoroethylene, 1-hydropentafluoropropene, and 2-hydropentafluoropropene. Additional cure site momomers include bromine-containing olefins and iodine-containing olefins such as 4-bromotetrafluorobutene-1 and bromotrifluoroethylene. Also, bromine or iodine atoms located at the terminal ends of the copolymer chains may act as cure sites. Such sites are formed when a bromine or iodine containing chain transfer agent is used in the polymerization of the copolymer.

What is claimed is:

1. A pipe joint comprising two pipes each having grooved ferrule ends having a flat sealing region adjacent to the interior of each of the pipes and a seal assembly positioned in the grooved ferrules of the pipes and a clamping means positioned around the pipe joint for applying pressure to the pipe joint;
wherein the seal assembly comprises an annular retaining part having a seal cavity and an elastomeric seal shaped to fit within said cavity and being positioned by said cavity;
wherein the annular retaining part comprises in cross section a bowl shaped portion, said bowl shaped portion having an opening and defining an annular interior cavity, said opening having a diameter less than the maximum diameter of the annular cavity within said bowl shaped portion and having an interior surface adjacent to the bowl opening having a seal retaining region; and
wherein the elastomeric seal has an annular forward seal portion larger in diameter than the diameter of the bowl opening into the annular interior cavity, said annular forward seal portion having an arcual forward surface comprising in cross section, a first and second convex arcual portion separated by a trough-like portion and a base surface for positioning against the seal retaining region of the bowl shaped portion and said seal having a substantially rectangularly shaped stem portion and having a rear surface, said surface being substantially concave in shape when in the uncompressed state;
whereby sufficient compression is applied by the clamping means to form a seal between the flat region of the two pipes and the rectangularly shaped stem portion of the seal and the stem being deformed under compression to form a nearly flat rear surface on the stem thereby forming nearly flat surface substantially even with the interior surface of the two pipes.

2. The pipe joint of claim 1 wherein the seal retaining region of the annular retaining part in cross section is a flat surface that is substantially perpendicular to the longitudinal axis of the annular retaining part and the base surface of the elastomeric seal is substantially flat and fits with the flat surface of the annular retaining part.

3. The pipe joint of claim 1 in which there is sufficient area for thermal expansion of the seal operating under elevated temperature conditions by providing for an expansion region between the forward portion of the seal and the interior cavity of the annular retaining part.

4. The pipe joint of claim 1 in which the elastomeric seal of the seal assembly is formed from a material selected from the group consisting of ethylene-propylene-diene elastomers, silicone rubbers, fluoroelastomers and perfluoroelastomers.

5. The pipe joint of claim 4 in which the elastomeric seal is formed from a perfluoroelastomer selected from the group consisting of copolymers comprising units of tetrafluoroethylene and units of a perfluoro(alkyl vinyl ether) and copolymers comprising units of tetrafluoroethylene and units of a perfluoro(alkoxy vinyl ether).

6. The pipe joint of claim 1 in which the annular retaining part of the seal assembly is formed from a metal.

7. The pipe joint of claim 6 in which the annular retaining part is formed from a metal selected from the group consisting of aluminum and stainless steel.

8. The pipe joint of claim 1 in which the annular retaining part is formed from a polymeric material selected from the group consisting of polyamides, polyetherether ketoses, polysulfones, polytetrafluoroethylenes and polyimides wherein the polymeric material has a modulus or hardness greater than that of the elastomeric seal.

9. A seal assembly comprising an annular retaining part having a seal cavity and an elastomeric seal shaped to fit within said cavity and being positioned in said cavity;
wherein the annular retaining part comprises in cross section a bowl shaped portion, said bowl shaped portion having an opening and defining an annular interior cavity said opening having a diameter less than the maximum diameter of the annular cavity within said bowl shaped portion and having an interior surface adjacent the bowl opening having a seal retaining region extending around the periphery of the opening; and
wherein the elastomeric seal comprises in cross section an annular forward seal portion larger in diameter than the diameter of the bowl opening into the annular interior cavity, said annular forward seal portion having an arcual forward surface comprising in cross section, a first and second convex arcual portion separated by a trough like portion and a base surface for positioning against the seal retaining region of the bowl shaped portion and said seal having a substantially rectangularly shaped stem portion that provides a sealing region and said stem portion having a rear surface being concave in shape capable of being deformed under pressure to a substantially flat surface.

10. The seal assembly of claim 9 wherein the seal retaining region of the annular retaining part in cross section is a substantially flat surface that is substantially perpendicular to the longitudinal axis of the annular retaining part and the base surface of the elastomeric seal is substantially flat and fits with the flat surface of the annular retaining part.

11. The seal assembly of claim 10 in which the longitudinal axis of said stem and the longitudinal axis of the bowl portion of the retaining part are coincident.

12. The seal assembly of claim 9 in which the elastomeric seal is formed from a material selected from the group consisting of ethylene-propylene-diene elastomers, silicone rubbers, fluoroelastomers and perfluoroelastomers.

13. The seal assembly of claim 9 in which the elastomeric seal is formed from a perfluoroelastomer selected from the group consisting of copolymers comprising units of tetrafluoroethylene and units of a perfluoro(alkyl vinyl ether) and copolymers comprising units of tetrafluoroethylene and units of a perfluoro(alkoxy vinyl ether).

14. The seal assembly of claim 9 in which the annular retaining part is formed from a metal.

15. The seal assembly of claim 14 in which the annular retaining part is formed from a metal selected from the group consisting of aluminum and stainless steel.

16. The seal assembly of claim 9 in which the annular retaining part is formed from a polymeric material selected from the group consisting of polyamides, polyetherether ketones, polysulfones, polytetrafluoroethylenes and polyimides wherein the polymeric material has a modulus or hardness greater than that of the elastomeric seal.

17. An annular elastomeric seal having an annular forward seal portion having an arcual forward surface comprising in cross section, a first and second convex arcual portion separated by a trough like portion and a base surface and a stem portion, said stem portion being rectangularly shaped and having a forward surface connected to the forward seal portion and a rear surface, said rear surface being concave shaped.

18. The elastomeric seal of claim 17 having a base surface which is substantially flat.

19. The elastomeric seal of claim 17 in which the seal is formed from a material selected from the group consisting of ethylene-propylene-diene elastomers, silicone rubbers, fluoroelastomers and perfluoroelastomers.

20. The elastomeric seal of claim 19 in which the seal is formed from a perfluoroelastomer selected from the group consisting of copolymers comprising units of tetraf luoroethylene and units of a perf luoro(alkyl vinyl ether) and copolymers comprising units of tetrafluoroethylene and units of a perfluoro(alkoxy vinyl ether).
